(19) United States
(12) Patent Application Publication
(10) Pub. No.: US 2024/0072574 A1
(43) Pub. Date: Feb. 29, 2024

(54) WIRELESS CHARGING METHOD AND APPARATUS, AND STORAGE MEDIUM

(71) Applicant: GUANGDONG OPPO MOBILE TELECOMMUNICATIONS CORP., LTD., Dongguan (CN)

(72) Inventors: Hongguang GUO, Dongguan (CN); Chen TIAN, Dongguan (CN); Jialiang ZHANG, Dongguan (CN)

(73) Assignee: GUANGDONG OPPO MOBILE TELECOMMUNICATIONS CORP., LTD., Dongguan (CN)

(21) Appl. No.: 18/505,261

(22) Filed: Nov. 9, 2023

Related U.S. Application Data
(63) Continuation of application No. PCT/CN2022/085374, filed on Apr. 6, 2022.

(30) Foreign Application Priority Data
May 18, 2021 (CN) 202110540847.9

(51) Int. Cl. H02J 50/12; H02J 7/00

(52) U.S. Cl. CPC H02J 50/12; H02J 7/00712

(57) ABSTRACT

The present application provides a wireless charging method, a wireless charging apparatus, and a storage medium. The method includes: detecting, in response to performing wireless charging, a charging parameter of a converter, wherein the charging parameter includes at least one parameter of an input current, an input voltage, an output current and an output voltage; determining a target operation mode according to the charging parameter, wherein the target operation mode is configured to determine a power-drawing mode of the converter; and controlling the converter to switch to the target operation mode, and charging a to-be-charged device.

### CROSS REFERENCE TO RELATED APPLICATIONS

This application is a continuation of International Patent Application No. PCT/CN2022/085374, filed Apr. 6, 2022, which claims priority to Chinese Patent Application No. 202110540847.9, filed May 18, 2021, both of which are herein incorporated by reference in their entirety.

### TECHNICAL FIELD

The present disclosure relates to the technical field of wireless charging, in particular to a wireless charging method, a wireless charging apparatus and a storage medium.

### BACKGROUND

Generally, during a charging process, a DC/DC converter of a wireless charging apparatus supplies power to an inverter unit in a constant voltage (CV) mode or a constant power (CP) mode, and obtains power from a front-stage adapter in the CP mode or a constant current (CC) mode. At this point, in order to ensure a stable operation of the wireless charging apparatus, it is necessary for the front-stage adapter to operate in the CV mode.

However, if a rated power of the adapter is not great enough, the wireless charging apparatus will encounter a problem of charging interruption when the charging power is increased. If the rated power of the adapter is increased, a waste of power of the adapter during the charging process may arise. It can be seen that, the existing wireless charging methods have low intelligence and poor stability.

### SUMMARY OF THE DISCLOSURE

A wireless charging method, a wireless charging apparatus and a storage medium are provided in embodiments of the present disclosure.

According to a first aspect of the present disclosure, a wireless charging method is provided. The method includes: detecting, in response to performing wireless charging, a charging parameter of a converter, wherein, the charging parameter includes at least one parameter of an input current, an input voltage, an output current, and an output voltage; determining, based on the charging parameter, a target operating mode, wherein, the target operating mode is configured to determine a power-drawing mode of the converter; controlling the converter to switch to the target operating mode, and charging a to-be-charged device based on the target operating mode.

According to a second aspect of the present disclosure, a wireless charging apparatus is provided. The wireless charging apparatus includes a processor, a memory and a detecting module. The memory stores an instruction capable of being executed by the processor. The detecting module is configured to: detect, in response to performing the wireless charging, the charging parameter of the converter, the charging parameter includes at least one parameter of the input current, the input voltage, the output current, and the output voltage. The processor is configured to: determine, based on the charging parameter, the target operating mode, the target operating mode is configured to determine the power-drawing mode of the converter; and control the converter to switch to the target operating mode, and charge the to-be-charged device based on the target operating mode.

According to a third aspect of the present disclosure, a non-transitory computer-readable storage medium is provided. The non-transitory computer-readable storage medium stores a program and is applied in a wireless charging apparatus. The program, when being executed by a processor, is configured to implement the wireless charging method. The method includes: detecting, in response to performing wireless charging, a charging parameter of a converter, wherein, the charging parameter includes at least one parameter of an input current, an input voltage, an output current, and an output voltage; determining, based on the charging parameter, a target operating mode, wherein, the target operating mode is configured to determine a power-drawing mode of the converter; controlling the converter to switch to the target operating mode, and charging a to-be-charged device based on the target operating mode.

### BRIEF DESCRIPTION OF THE DRAWINGS

FIG. 1 is a schematic diagram of a wireless charging system.

FIG. 2 is a schematic diagram of an implementation of a wireless charging manner.

FIG. 3 illustrates a first schematic flowchart for implementing the wireless charging method according to an embodiment of the present disclosure.

FIG. 4 illustrates a second schematic flowchart for implementing the wireless charging method according to an embodiment of the present disclosure.

FIG. 5 illustrates a first schematic diagram for implementing the wireless charging according to an embodiment of the present disclosure.

FIG. 6 illustrates a second schematic diagram for implementing the wireless charging according to an embodiment of the present disclosure.

FIG. 7 illustrates a schematic diagram of an operating mode of a common wireless charging apparatus.

FIG. 8 illustrates a first schematic diagram of a wireless charging.

FIG. 9 illustrates a second schematic diagram of the wireless charging.

FIG. 10 illustrates a third schematic diagram of the wireless charging.

FIG. 11 is a first schematic diagram of the operating mode control during a charging process.

FIG. 12 is a second schematic diagram of the operating mode control during the charging process.

FIG. 13 is a first schematic structural diagram illustrating a composition of a wireless charging apparatus according to an embodiment of the present disclosure.

FIG. 14 is a second schematic structural diagram illustrating the composition of the wireless charging apparatus according to an embodiment of the present disclosure.

### DETAILED DESCRIPTION

Technical schemes in embodiments of the present disclosure will be described clearly and thoroughly in connection with accompanying drawings of the embodiments of the present disclosure. The specific embodiments described herein are intended for explaining the related disclosure only, and are not for limiting the present disclosure. In addition, for ease of description, only a part relevant to the corresponding disclosure is illustrated in the accompanying drawings.

In the related art, FIG. 1 is a schematic diagram of a wireless charging system. As illustrated in FIG. 1, the wireless charging system 10 includes a power supply device 110, a wireless charging apparatus 120 and a to-be-charged device 130. The power supply device 110 may be, for example, an adapter. The wireless charging apparatus 120 may be, for example, a wireless charging dock or a wireless charging seat. The to-be-charged device 130 may be, for example, a terminal device.

After the power supply device 110 is connected to the wireless charging apparatus 120, an output voltage and an output current of the power supply device 110 may be transmitted to the wireless charging apparatus 120.

The wireless charging apparatus 120 may convert, by means of a wireless charging transmitting unit 121, the output voltage and the output current of the power supply device 110 into a wireless charging signal (electromagnetic signal) for transmission. The wireless charging transmitting unit 121 is arranged in the wireless charging apparatus 120. For example, the wireless charging transmitting unit 121 may convert the output current of the power supply device 110 into an alternating current. The wireless charging transmitting unit 121 may further convert, through a transmitting coil or a transmitting antenna, the alternating current into the wireless charging signal.

The to-be-charged device 130 may receive the wireless charging signal emitted by the wireless charging transmitting unit 121 through a wireless charging receiving unit 131. The to-be-charged device 130 may further convert the wireless charging signal into an output voltage and an output current of the wireless charging receiving unit 131. For example, the wireless charging receiving unit 131 may convert the wireless charging signal emitted by the wireless charging transmitting unit 121 into an alternating current through a receiving coil or a receiving antenna. The wireless charging receiving unit 131 may further perform operations such as rectifying and/or filtering etc. on the alternating current, and convert the alternating current into the output voltage and the output current of the wireless charging receiving unit 131.

The wireless power technology originates from a wireless electrical-energy transmission technology. Nowadays, wireless charging functions are becoming more and more popular, and the charging power also keeps increasing. Accordingly, the wireless charging apparatuses are also becoming more and more popular, and the power also keeps increasing. At the same time, requirements for the adapter that supplies power to the wireless charging apparatus are also getting higher and higher. For example, at present, the wireless charging power of a cell phone has reached up to 80 W, while a power of ancillary adapter or an assorted adapter needs to exceed 100 W. In addition, at the current stage, the wireless charging power adopted by cell phone manufacturers of domestic leading brands is generally in a range of 40 W˜60 W etc. Generally, an adapter with a rated power much greater than the wireless charging power is adopted to support the charging process.

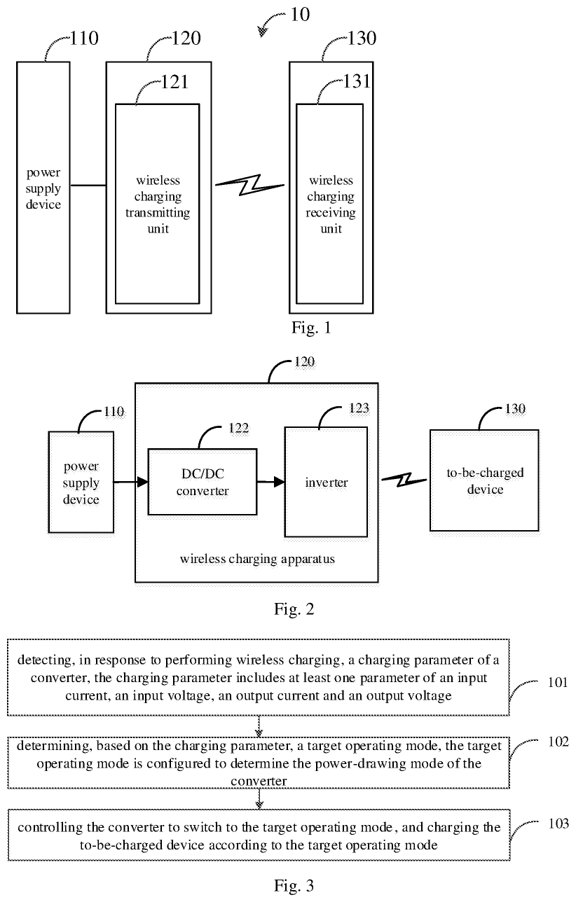

FIG. 2 is a schematic diagram of an implementation of a wireless charging manner. As illustrated in FIG. 2, the wireless charging apparatus 120 receives a constant voltage from a direct current (DC) power supply device 110. A DC/DC converter 122 scales the constant voltage and applies the scaled constant voltage to an inverter 123. The inverter 123 may for example be a direct current-alternating current (DC-AC) inverter, and may be configured to convert a direct current voltage (Vsdc) to an alternating current voltage (Vsac). The inverter 123, together with a transmitter matching network, generates an alternating current (AC) in a transmitting coil. The AC current in the transmitting coil generates an oscillating magnetic field according to Ampere's law. The oscillating magnetic field induces, according to Faraday's law, an AC voltage in a well-tuned receiving coil. The receiving coil is arranged in the to-be-charged device 130.

DC/DC means DC to DC conversion. i.e., a DC power supply value is converted to a different DC power supply value. If a converter is capable of converting a DC voltage (3.0V) to another DC voltage (1.5V or 5.0V), then the converter may be referred to as a DC/DC converter, or as a switching power supply or a switching regulator.

Generally, during a charging process, the DC/DC converter of the wireless charging apparatus supplies power to an inverter unit in a Constant Voltage (CV) mode or Constant Power (CP) mode, and obtains power from a front-stage adapter in the CP mode or a Constant Current (CC) mode. In this case, in order to ensure a stable operation of the wireless charging apparatus, it is necessary for the front-stage adapter to operate in the CV mode. This requires that, a rated power of the adapter must be greater than a maximum power peak value obtained by the wireless charging apparatus, or else there will be problems of charging breakdown or charging interruption or even problems of failing to charge. However, as the charging process continues, the cell phone's battery level or electricity amount is gradually boosted, and the charging power is gradually decreased. The adaptor enters a low-loading mode, and a charging capacity of the adapter is far from being utilized.

In some embodiments of the present disclosure, on the one hand, as charging power of an intelligent terminal product becomes increasingly great, the output power of the corresponding adapter grows increasingly great as well. However, since most of the terminal products will reduce the charging power after charging for a time period, at this point, power demand for the adapter will gradually decrease. If the rated power of the adapter is designed to be a maximum power demanded by the terminal product, a great waste would be inevitable. That is, an output capacity of the adapter is far from being utilized.

On the other hand, with regard to the adapter that supplies power to the wireless charging apparatus, since the wireless charging apparatus operates in the CC power-drawing mode or the CP power-drawing mode, and an efficiency of the wireless charging system is relatively low, thus the ancillary adapter requires a greater rated output power, in order to ensure that the wireless charging apparatus is capable of obtaining the maximum power peak value for charging the terminal device. If the rated power of the adapter is not great enough, when the charging power of the wireless charging apparatus is boosted, the wireless charging apparatus may encounter a problem of intermittent charging or even encounter the problem of failing to charge.

In the current common wireless charging methods, if the rated power of the adapter is not great enough, when the wireless charging apparatus boosts the charging power, a problem of charging interruption may occur. If the rated power of the adapter is increased, a waste of adapter power will be resulted during the charging process. It can be seen that, the existing wireless charging methods have low intelligence and poor stability.

In order to solve the above-mentioned problems, the present disclosure proposes a wireless charging method. The wireless charging method may control the DC/DC converter of the wireless charging apparatus to operate in various power-drawing modes, such as in the CV power-drawing mode, the CP power-drawing mode etc., and to be able to seamlessly switch or shift between the various operating modes including the CV operating mode and the CP operating mode etc. Based on the charging power supplied by the wireless charging apparatus to the terminal device, and the charging power supplied by the adapter to the wireless charging apparatus, switching of the two modes is seamlessly performed during the charging process. In this way, a stable charging process is ensured. When the DC/DC converter operates in the CP power-drawing mode, the charging power is controlled by the DC/DC converter, and at this point, the adapter is capable of providing sufficient power, to meet the demand of the wireless charging apparatus for charging the terminal device.

In some embodiments of the present disclosure, during the charging process, based on a voltage and a current supplied by the wireless charging apparatus to the to-be-charged device for charging, and a voltage and a current supplied by the adapter to the wireless charging apparatus, the DC/DC converter of the wireless charging apparatus may be controlled to operate in various power-drawing modes including the CV power-drawing mode, the CP power-drawing mode or etc. A stable charging process is thus ensured. When the DC/DC converter operates in the CP power-drawing mode, the charging power is controlled by the DC/DC converter, and at this point, the adapter is capable of providing sufficient power, to meet the demand of the wireless charging apparatus for charging the terminal device. When the DC/DC converter operates in the CV power-drawing mode, the charging power is controlled by the adapter, and at this point, the adapter is no longer forced to supply the maximum charging power, which in turn eliminates the problem of charging interruption.

Technical schemes in embodiments of the present disclosure will be described clearly and thoroughly in connection with accompanying drawings of the embodiments of the present disclosure.

According to some embodiments of the present disclosure, the wireless charging method is provided. FIG. 3 illustrates a first schematic flowchart for implementing the wireless charging method according to an embodiment of the present disclosure. In some embodiments of the present disclosure, the wireless charging method performed by the wireless charging apparatus may include operations illustrated at blocks of FIG. 3.

At block 101: detecting, in response to performing wireless charging, a charging parameter of a converter. The charging parameter includes at least one parameter of an input current, an input voltage, an output current and an output voltage.

In some embodiments of the present disclosure, the wireless charging apparatus, when performing the wireless charging, may first detect charging parameters corresponding to the converter. The charging parameter includes at least one parameter of the input current, the input voltage, the output current and the output voltage. In some embodiments, the wireless charging apparatus may detect one or more parameters of the input current, the input voltage, the output current and the output voltage of the converter.

Further, in some embodiments of the present disclosure, the wireless charging apparatus may be configured with the converter. When performing the wireless charging, the wireless charging apparatus may convert a DC voltage to another DC voltage through the converter. That is, the converter configured in the wireless charging apparatus may be a DC/DC converter.

In some embodiments of the present disclosure, the wireless charging apparatus may be a component of the wireless charging system. In some embodiments of the present disclosure, the wireless charging system may further include the to-be-charged device and the power supply device. The power supply device may be configured to charge the wireless charging apparatus. The wireless charging apparatus may wirelessly charge the to-be-charged device by establishing a wireless connection with the to-be-charged device. For example, the power supply device may be a device such as an adapter, a power supply etc. The wireless charging apparatus may be a device such as a charging dock etc. The to-be-charged device may be a device such as a cell phone, a game console etc.

In some embodiments of the present disclosure, the to-be-charged device may be any terminal device equipped with communication and storage functions, such as a tablet computer, a cell phone, an E-reader, a remote controller, a personal computer (PC), a laptop computer, a vehicle-mounted device, an Internet TV, a wearable device, a personal digital assistant (PDA), a portable media player (PMP) or a navigation apparatus etc.

The power supply device provides a power supply for the wireless charging apparatus. Meanwhile, a wireless communication technology may be adopted between the wireless charging apparatus and the to-be-charged device, to realize charging of a battery in the to-be-charged device by the electromagnetic induction.

Further, in some embodiments of the present disclosure, prior to performing wireless charging, the to-be-charged device may first establish wireless connection with the wireless charging apparatus and conduct a bidirectional communication with the wireless charging apparatus, so as to realize the wireless charging.

In some embodiments of the present disclosure, the wireless communication may also be established between the power supply device and to-be-charged device, such that a bidirectional data transmission may be realized.

Further, in some embodiments of the present disclosure, the power supply device may be configured to charge the wireless charging apparatus. In some embodiments of the present disclosure, the power supply device and the wireless charging apparatus may be connected through a Universal Serial Bus (USB) interface. The USB interface may be a common USB interface, a micro USB interface or a Type C interface, etc. A power wire in the USB interface is configured to enable the power supply device to charge the wireless charging apparatus. The power wire in the USB interface may be a VBus wire and/or a ground wire in the USB interface. A data wire in the USB interface is configured to enable the power supply device and the wireless charging apparatus to conduct the bidirectional communication. The data wire may be a D+ wire and/or a D− wire in the USB interface. The so-called bidirectional communication may refer to information interaction between the power supply device and the wireless charging apparatus.

Further, in some embodiments of the present disclosure, the power supply device may support a normal charging mode and a rapid charging mode. A charging current flow of the rapid charging mode is greater than that of the normal charging mode. That is, a charging speed of the rapid charging mode is greater than that of the normal charging mode.

In some embodiments of the present disclosure, the power supply device may be connected to the converter in the wireless charging apparatus. Therefore, the voltage output in real-time from the power supply device to the wireless charging apparatus is an input voltage of the converter. In some embodiments of the present disclosure, the wireless charging apparatus may perform, through the converter, voltage conversion on the voltage output in real-time from the power supply device, i.e. the input voltage of the converter, so as to obtain and supply the output voltage.

Correspondingly, in the present disclosure, it is exactly because connection between the power supply device and the converter of the wireless charging apparatus, that the current output from the power supply device to the wireless charging apparatus in real-time is the input current of the converter.

Further, in some embodiments of the present disclosure, when the power supply device performs charging to the wireless charging apparatus, an output mode of the power supply device may be the constant current (CC) mode or the constant voltage (CV) mode.

Operating in the CC mode means that, the power supply device supplies a constant current output for the purpose of providing a stable current. In some embodiments of the present disclosure, when the power supply device operates in the CC mode, in order to ensure the output of the stable current: if the output power increases, then the output voltage increases; and if the output power decreases, then the output voltage decreases.

Operating in the CV mode means that, the power supply device supplies a constant voltage output for the purpose of providing a stable voltage. In some embodiments of the present disclosure, when the power supply device operates in the CV mode, in order to ensure the output of the stable voltage: if the output power increases, then the output current increases; and if the output power decreases, then the output current decreases.

Further, in some embodiments of the present disclosure, when the power supply device performs charging to the wireless charging apparatus, the power-drawing mode of the wireless charging apparatus may be the constant current (CC) mode, the constant power (CP) mode, or the constant voltage (CV) mode etc.

Operating in the CC mode means that, the wireless charging apparatus draws power at a constant current for the purpose of obtaining a stable current. In some embodiments, when the wireless charging apparatus operates in the CC mode, in order to ensure the obtaining of the stable current: if the power required by the to-be-charged device increases, then the voltage obtained by the wireless charging apparatus is increased; and if the power required by the to-be-charged device decreases, then the voltage obtained by the wireless charging apparatus is decreased.

Operating in the CV mode means that, the wireless charging apparatus draws power at a constant voltage for the purpose of obtaining a stable voltage. In some embodiments, when the wireless charging apparatus operates in the CV mode, and the rated power supplied by the power supply device is able to meet the maximum power for the wireless charging apparatus to wirelessly charge the to-be-charged device, then in order to ensure that the stable voltage is obtained: if the power required by the to-be-charged device increases, then the current obtained by the wireless charging apparatus is increased; and if the power required by the to-be-charged device decreases, then the current obtained by the wireless charging apparatus is decreased.

Operating in the CP mode means that, the wireless charging apparatus draws power at a constant power for the purpose of obtaining a stable power. In some embodiments of the present disclosure, when the wireless charging apparatus operates in the CP mode, and the power supply device operates in the CV mode, in order to ensure that the stable power is obtained: if the power required by the to-be-charged device increases, then the current obtained by the wireless charging apparatus is increased; and if the power required by the to-be-charged device decreases, then the current obtained by the wireless charging apparatus is decreased.

Further, in some embodiments of the present disclosure, the wireless charging apparatus may detect the input current, the input voltage, the output current, and the output voltage through a control circuit. The control circuit is arranged in the converter. In some embodiments, the wireless charging apparatus may also detect the input current, the input voltage, the output current, and the output voltage through a controller.

In other words, in some embodiments of the present disclosure, the wireless charging apparatus may detect charging parameters such as the input current, the input voltage, the output current, the output voltage etc. of the converter in various ways. In some embodiments of the present disclosure, the wireless charging apparatus may perform monitoring and acquisition of charging parameters either directly through the converter or through the configured controller. The present disclosure will not be specifically limited.

As an example, in the present disclosure, the DC/DC converter may be provided with the control circuit internally. The control circuit may perform detection of the charging parameters of the DC/DC converter.

As an example, in the present disclosure, the wireless charging apparatus may further be configured with the controller external to the DC/DC converter. The controller may detect the charging parameters of the DC/DC converter.

At block 102: determining, based on the charging parameter, a target operating mode. The target operating mode is configured to determine the power-drawing mode of the converter.

In some embodiments of the present disclosure, the wireless charging apparatus, after detecting the charging parameter of the converter, may further determine, based on the charging parameter, the target operating mode. The charging parameter include at least one parameter such as the input current, the input voltage, the output current, and the output voltage etc.

In the present disclosure, the target operating mode is a power-drawing mode determined by the converter of the wireless charging apparatus in order to adapt the charging parameter. The target operating mode may include, but is not limited to, any of the following power-drawing modes: the CC mode, the CV mode, the CP mode, and a constant resistor (CR) mode.

As an example, in some embodiments of the present disclosure, the power-drawing mode is the way in which the wireless charging apparatus obtains power from the power supply device. For example, when the target operating mode is the CP mode, the power-drawing mode of the converter is determined as the constant power mode. That is to say, the converter draws power from the power supply device at a constant power. In order to ensure that the power is constant, when the voltage supplied by the power supply device increases, the current at which the converter “eats power” decreases correspondingly; and when the voltage supplied by the power supply device decreases, the current at which the converter “eats power” increases correspondingly. When the target operating mode is the CV mode, the power-drawing mode of the converter is determined as the constant voltage mode. That is to say, the converter draws power from the power supply device at a constant voltage. When the current supplied by the power supply device increases, the power obtained by the converter increases correspondingly; and, when the current supplied by the power supply device decreases, the power obtained by the converter decreases correspondingly. When the target operating mode is the CC mode, the power-drawing mode of the converter is determined as the constant current mode. That is to say, the converter draws power from the power supply device at a constant current. When the voltage supplied by the power supply device decreases, the power obtained by the converter decreases correspondingly; and when the voltage supplied by the power supply device increases, the power obtained by the converter increases correspondingly. When the target operating mode is the CR mode, it is determined that the power-drawing mode of the converter is a mode in which the ratio of the voltage to the current is constant. In other words, the converter draws power from the power supply device as per the constant ratio of the voltage to the current.

In some embodiments of the present disclosure, in different charging phases, the charging power required to be supplied by the wireless charging apparatus to the to-be-charged device is different. Correspondingly, in different charging phases, the charging parameters detected by the wireless charging apparatus are also different. As a result, the target operating modes, which are determined based on the charging parameters such as the input current, the input voltage, the output current and the output voltage, may vary with a charging duration.

In some embodiments of the present disclosure, in the process of determining, based on the charging parameter including at least one parameter of the input current, the input voltage, the output current, and the output voltage etc., the target operating mode, the wireless charging apparatus may first determine, based on the output current and the output voltage, a real-time charging power. If the real-time charging power is less than a preset power threshold, then the target operating mode is determined as the constant power CP mode.

In some embodiments of the present disclosure, the wireless charging apparatus may first determine, based on the detected output current and output voltage, the charging power for wireless charging the to-be-charged device, i.e., the real-time charging power. The wireless charging apparatus may then compare the real-time charging power with the preset threshold value, i.e., the preset power threshold value, so as to determine, based on the comparison result, the target operating mode of the converter corresponding to the charging parameters.

In the present disclosure, the preset power threshold may be a specific value preset by the wireless charging apparatus, and for selecting the operating mode of the converter. For example, the wireless charging apparatus may set the preset power threshold in accordance with the peak charging power of the to-be-charged device. For example, the preset power threshold is set equal to the peak charging power, or the preset power threshold is set equal to ½ of the peak charging power.

For example, in the present disclosure, during an initial phase of the charging period, if the output current detected by the wireless charging apparatus is 1 A and the output voltage detected is 5V, then at this point, the real-time charging power of the wireless charging apparatus is relatively small and is 5 W. At this point, the power supplied by the power supply device is capable of meeting the charging demand of the wireless charging apparatus. The output mode of the power supply device is the CV mode. Correspondingly, the target operating mode of the converter may be determined by the wireless charging apparatus as the CP mode.

That is, in the present disclosure, for the initial phase of the charging period, the charging power supplied by the wireless charging apparatus to the to-be-charged device is relatively small, and the power that is able to be supplied by the power supply device may meet the demand of the wireless charging apparatus for performing wireless charging to the to-be-charged device. At this point, the power supply device operates in the CV output mode, and the DC/DC converter of the wireless charging apparatus operates in the CP power-drawing mode.

In some embodiments of the present disclosure, in the process of determining, based on the charging parameter including at least one parameter of the input current, the input voltage, the output current, and the output voltage etc., the target operating mode, the wireless charging apparatus may first determine, based on the input current and the input voltage, the charging power supplied by the power supply device, i.e., the real-time input power. The wireless charging apparatus may simultaneously determine, based on the output current and the output voltage, the real-time charging power. If the real-time charging power is equal to the real-time input power and the real-time charging power is equal to a power upper limit, then the target operating mode is determined as the CP mode.

In some embodiments of the present disclosure, the wireless charging apparatus may first determine, based on the detected output current and output voltage, the charging power for wireless charging the to-be-charged device, i.e., the real-time charging power. The wireless charging apparatus may simultaneously further determine, based on the detected input current and input voltage, the charging power transmitted by the power supply device, i.e., the real-time input power. The wireless charging apparatus may then further compare the real-time charging power with the real-time input power, and simultaneously compare the real-time charging power with the preset power upper limit. The wireless charging apparatus may thereby determine, based on the comparison results, the target operating mode of the converter corresponding to the charging parameter.

In the present disclosure, the power upper limit may be the maximum power value of the wireless charging apparatus for charging the to-be-charged device, i.e., the charging peak power corresponding to the to-be-charged device. For example, the maximum power value, i.e. the power upper limit, for wireless charging the to-be-charged device is 65 W (10V/6.5 A).

As an example, in the present disclosure, as the charging duration increases, the wireless charging apparatus enters the rapid charging phase. At this point, the real-time charging power of the wireless charging apparatus is elevated to the power upper limit of 65 W. If the power supplied by the power supply device is capable of meeting the charging demand of the wireless charging apparatus at this point, i.e., the power supply device may also supply the charging power that is no less than 65 W within a short time period, then the output mode of the power supply device shall be the CV mode. Correspondingly, the target operating mode of the converter may be determined by the wireless charging apparatus as the CP mode.

In other words, in some embodiments of the present disclosure, during the rapid charging phase, the charging power supplied by the wireless charging apparatus to the to-be-charged device reaches the peak power. That is, the real-time charging power is equal to the power upper limit. If the power supplied by the power supply device may also meet the demand of the wireless charging apparatus for wirelessly charging the to-be-charged device, then the power supply device operates in the CV output mode, and the DC/DC converter of the wireless charging apparatus operates in the CP power-drawing mode.

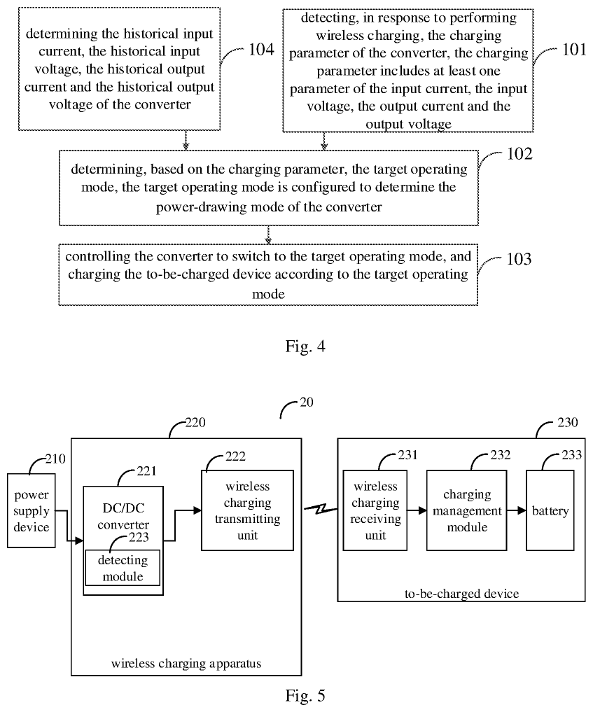

Further, in some embodiments of the present disclosure, FIG. 4 illustrates a second schematic flowchart for implementing the wireless charging method according to an embodiment of the present disclosure. As illustrated in FIG. 4, prior to the operation in which the wireless charging apparatus determines, based on the charging parameter, the target operating mode, i.e., prior to the operation at the block 102, the wireless charging method performed by the wireless charging apparatus may further include operations illustrated at blocks of FIG. 4.

At block 104: determining a historical input current, a historical input voltage, a historical output current and a historical output voltage of the converter.

In some embodiments of the present disclosure, the wireless charging apparatus may continuously detect the charging parameters of the converter, so as to obtain the charging parameters of the converter at each moment. The charging parameters of the converter includes at least one parameter of the input current, the input voltage, the output current, and the output voltage etc. In comparison to the input current, the input voltage, the output current and the output voltage, the charging parameters detected and obtained at a previous moment are referred to as a historical input current, a historical input voltage, a historical output current and a historical output voltage respectively.

In some embodiments of the present disclosure, the wireless charging apparatus may perform real-time detection of the charging parameters, and store the detected charging parameters. In some embodiments, the wireless charging apparatus detects the charging parameters including the input current, the input voltage, the output current, and the output voltage at a first moment t1 and a second moment t2 respectively. The first moment t1 and the second moment t2 are adjacent to each other, and t2 is greater than t1. The input current detected at the first moment t1 may be stored as the historical input current. The input voltage detected at the first moment t1 may be stored as the historical input voltage. The output current detected at the first moment t1 may be stored as the historical output current. The output voltage detected at the first moment t1 may be stored as the historical output voltage. The input current, the input voltage, the output current, and the output voltage detected at the second moment t2 are stored as the real-time charging parameters. At a next consecutive moment, such as at a third moment t3, after the charging parameters including the input current, the input voltage, the output current, and the output voltage have been detected, the charging parameters at the second moment t2 may be used to overwrite the charging parameters at the first moment t1. t3 is greater than t2. That is, the input current detected at the second moment t2 may be stored as the historical input current. The input voltage detected at the second moment t2 may be stored as the historical input voltage. The output current detected at the second moment t2 may be stored as the historical output current. The output voltage detected at the second moment t2 may be stored as the historical output voltage. The input current, the input voltage, the output current, and the output voltage detected at the third moment t3 are stored as the real-time charging parameters.

In some embodiments of the present disclosure, in the process of determining, based on the charging parameter including at least one parameter of the input current, the input voltage, the output current, and the output voltage etc., the target operating mode, the wireless charging apparatus may first determine, based on the input current and the input voltage, the charging power supplied by the power supply device, i.e., the real-time input power. The wireless charging apparatus may simultaneously determine, based on the output current and the output voltage, the real-time charging power. If the real-time charging power is greater than or equal to the real-time input power, and the historical input voltage is greater than the input voltage, then the target operating mode may be determined as the constant voltage CV mode.

In some embodiments of the present disclosure, the wireless charging apparatus may first determine, based on the detected output current and output voltage, the charging power for wireless charging the to-be-charged device, i.e., the real-time charging power. The wireless charging apparatus may simultaneously further determine, based on the detected input current and input voltage, the charging power transmitted by the power supply device, i.e., the real-time input power. The real-time charging power is then compared with the real-time input power, meanwhile the historical input voltage is compared with the input voltage, such that the target operating mode of the converter corresponding to the charging parameters may be determined based on the comparison results.

In the present disclosure, if the historical input voltage is greater than the input voltage, it may be assumed that the power supply device is incapable of providing sufficiently great power to the wireless charging apparatus. In order to ensure a stable operation by itself, the power supply device switches from the CV output mode to the CC output mode.

As an example, in the present disclosure, as the charging duration increases, the wireless charging apparatus enters the rapid charging phase. The real-time charging power of the wireless charging apparatus needs to be gradually increased to the power upper limit of 65 W. Assuming that the real-time charging power of the wireless charging apparatus is increased to 60 W at this point, if the power supplied by the power supply device is incapable of meeting the charging demand of the wireless charging apparatus at this point, i.e., the rated power of the power supply device can't reach 65 W, or even 60 W, then the power supply device, in order to maintain its own stable operation, would switch the output mode from the CV mode to the CC mode. Correspondingly, the target operating mode of the converter may be determined by the wireless charging apparatus as the CV mode.

In other words, in some embodiments of the present disclosure, during the rapid charging phase, the charging power supplied by the wireless charging apparatus to the to-be-charged device reaches the peak power. That is, the real-time charging power is equal to the power upper limit. If the power supplied by the power supply device is incapable of meeting the demand of the wireless charging apparatus for wirelessly charging the to-be-charged device, i.e., the rated power of the power supply device is less than the power upper limit, then the power supply device needs to be switched from the CV output mode to the CC output mode, and the DC/DC converter of the wireless charging apparatus operates in the CV power-drawing mode.

Correspondingly, in the present disclosure, during the rapid charging phase, the charging power supplied by the wireless charging apparatus to the to-be-charged device gradually increases towards the peak power. That is, the real-time charging power is less than or equal to the power upper limit. If the power supplied by the power supply device is incapable of meeting the demand of the wireless charging apparatus for wirelessly charging the to-be-charged device, i.e., the rated power of the power supply device is less than the real-time charging power, then the power supply device needs to be switched from the CV output mode to the CC output mode, and the DC/DC converter of the wireless charging apparatus operates in the CV power-drawing mode.

As an example, in the present disclosure, as the charging duration increases, the wireless charging apparatus enters a stabilization phase. At this point, the real-time charging power of the wireless charging apparatus is elevated to the power upper limit of 65 W. The power supply device, after meeting the charging demand of the wireless charging apparatus for a time period in accordance with the power of 65 W, is unable to continue supplying the maximum power, and needs to enter a power reduction phase. In other words, the power supply device needs to reduce the power to ensure its own stable operation, and thus the output mode will be switched from the CV mode to the CC mode. Correspondingly, the target operating mode of the converter may be determined by the wireless charging apparatus as the CV mode.

In other words, in some embodiments of the present disclosure, during the stabilization phase, the charging power supplied by the wireless charging apparatus to the to-be-charged device reaches the peak power. That is, the real-time charging power is equal to the power upper limit. If the power supplied by the power supply device is capable of meeting the demand of the wireless charging apparatus for wirelessly charging the to-be-charged device, and after providing power to the wireless charging apparatus for a time period based on the power upper limit, the power supply device needs to enter the power reduction phase, be switched from the CV output mode to the CC output mode. The DC/DC converter of the wireless charging apparatus operates in the CV power-drawing mode.

In some embodiments of the present disclosure, when the target operating mode of the wireless charging apparatus is the CV mode, i.e., the DC/DC converter operates in the CV power-drawing mode, the wireless charging apparatus is no longer forced to obtain, from the power supply device, the maximum power for supplying the to-be-charged device. Instead, control authority of the charging power is handed over to the power supply device. That is, the charging to the to-be-charged device is performed in accordance with the charging power that can be supplied by the power supply device. At this point, the DC/DC converter of the wireless charging apparatus is configured for power transmission.

In some embodiments of the present disclosure, in the process that the wireless charging apparatus determines, based on the charging parameter including at least one parameter of the input current, the input voltage, the output current and the output voltage etc., the target operating mode, if the historical output current is greater than the output current and the historical input current is greater than the input current, then the target operating mode may be determined as the CP mode.

In some embodiments of the present disclosure, the wireless charging apparatus may compare the output current with the historical output current, and simultaneously compare the historical input current with the input current, thereby determining, based on the comparison results, the target operating mode of the converter corresponding to the charging parameters.

In the present disclosure, if the historical input current is greater than the input current and the historical output current is greater than the output current, it may be considered that the charging power required by the to-be-charged device is gradually decreasing. The power supply device is capable of supplying a sufficiently great amount of power to the wireless charging apparatus, to meet the demand of the wireless charging apparatus for wirelessly charging the to-be-charged device. Therefore, the power supply device operates in the CV output mode, and the DC/DC converter of the wireless charging apparatus operates in the CP power-drawing mode.

As an example, in the present disclosure, as the charging duration increases, the wireless charging apparatus enters the rapid-charging-exiting phase. If the historical output current corresponding to the converter is 5 A and the output current corresponding to the converter is 1 A, i.e., the output current is less than the historical output current, the historical input current corresponding to the converter is 8 A and the output current corresponding to the converter is 4 A, i.e., the input current is less than the historical input current, it may be considered that, the charging power supplied by the wireless charging apparatus to the to-be-charged device is gradually decreasing. Therefore, the charging current outputted by the wireless charging apparatus is decreasing. Accordingly, draw-out power of the wireless charging apparatus is also gradually decreasing, thus the output mode of the power supply device is the CV mode. Correspondingly, the target operating mode of the converter may be determined by the wireless charging apparatus as the CP mode.

In other words, in some embodiments of the present disclosure, during the rapid-charging-exiting phase, as the battery level of the to-be-charged device gradually increases, the power supplied by the power supply device may meet the demand of the wireless charging apparatus for wirelessly charging the to-be-charged device, then the power supply device operates in the CV output mode, and the DC/DC converter of the wireless charging apparatus operates in the CP power-drawing mode.

At block 103: controlling the converter to switch to the target operating mode, and charging the to-be-charged device according to the target operating mode.

In some embodiments of the present disclosure, after the process of determining, based on the charging parameter including at least one parameter of the input current, the input voltage, the output current, and the output voltage etc., the target operating mode, the wireless charging apparatus may control the converter to switch to the target operating mode, and charge the to-be-charged device according to the target operating mode.

In some embodiments of the present disclosure, if the target operating mode of the converter is determined as the CP mode, then after the converter is controlled to switch to the CP mode, the wireless charging apparatus, in the process of charging the to-be-charged device in accordance with the target operating mode, may first determine the real-time input power in accordance with the input current and the input voltage. The wireless charging apparatus may then determine the real-time input power as the target charging power, and charge the to-be-charged device in accordance with the target charging power.

In some embodiments of the present disclosure, if the target operating mode of the converter is determined as the CV mode, then after the converter is controlled to switch to the CV mode, the wireless charging apparatus, in the process of charging the to-be-charged device in accordance with the target operating mode, may first determine the real-time input power as the target charging power, and simultaneously determine the input voltage as a target charging voltage. The wireless charging apparatus may then charge the to-be-charged device according to the target charging power and the target charging voltage.

In summary, by means of the wireless charging method proposed in the above-mentioned operations at blocks 101 to 104, by controlling the operating mode of the converter (such as the DC/DC converter) of the wireless charging apparatus: on the one hand, the demand for the rated power of the power supply device may be reduced, i.e., the rated power of the power supply device is no longer required to be greater than the peak power during the wireless charging process. For example, when the DC/DC converter operates in the CV power-drawing mode, the power supply device is allowed to autonomously reduce its power, thereby solving problems of intermittent charging or even problems of failing to charge. These problems are caused by failure of the power supply device to supply sufficient power. On the other hand, the power supply device is allowed to operate at peak power for a short time period, so as to supply power to the to-be-charged device through the wireless charging apparatus. For example, when the DC/DC converter operates in the CP power-drawing mode, the output power of the power supply device may be boosted to the rated power. Therefore, the charging capacity of the power supply device may be fully utilized.

In other words, in the current situation, many adapters available in the market are capable of operating at peak power for a short time period, while the rated powers of the adapters are less than the peak power. Considering the fact that the time period that the to-be-charged device, which is represented by the cell phone and other terminal devices, is in the high-power charging state is also very short, and that once the battery level of the to-be charged device has been raised, the charging power would drop significantly, the wireless charging method is proposed in the embodiments of the present disclosure. In the wireless charging method, the charging parameters of the DC/DC converter may be set to be matched with different operating modes. Through controlling the operating modes of the DC/DC converter, the capability of the adapter may be fully utilized, enabling the adapter to exhaust its maximum capability to meet the demand of the wireless charging apparatus for charging the to-be-charged device. Meanwhile, on the premise of guaranteeing that the charging power of the to-be-charged device is met, the rated power of the adapter is no longer required to be greater than the charging peak power of the to-be-charged device. That is, the adapter whose rated power is not great enough is also capable of performing normal charging.

Further, in some embodiments of the present disclosure, the target operating mode of the converter may also be a CR mode. In other words, the wireless charging apparatus may also enable the converter to operate in the CR mode by adjusting the power-drawing mode of the converter. In this way, the converter is equivalent to a “controllable resistor” in the perspective view of a front-stage power supply unit. The charging voltage and charging current of the converter can thus be further guaranteed to be in-phase as far as possible. In conjunction with the front-stage circuits of the DCX and other applications, a relatively great power factor (PF) value is thereby achieved.

In some embodiments of the present disclosure, the DC/DC converter may exist in a variety of forms, which includes, but is not limited to a Buck circuit, a Boost circuit, a Buck-Boost circuit, a Flybuck, etc. The DC/DC converter is mainly responsible for connection and conversion functions between the front-stage power supply and the post-stage powered unit.

According to some embodiments of the present disclosure, a wireless charging method is provided. The wireless charging method includes: detecting, in response to the wireless charging apparatus performing the wireless charging, the charging parameter of the converter, the charging parameter includes at least one parameter of the input current, the input voltage, the output current, and the output voltage; determining, based on the charging parameter, the target operating mode, the target operating mode is configured to determine a power-drawing mode of the converter; controlling the converter to switch to the target operating mode, and charging the to-be-charged device according to the target operating mode. In other words, in some embodiments of the present disclosure, during the charging process, based on the voltage and the current supplied by the wireless charging apparatus to the to-be-charged device for charging, and based on the voltage and the current supplied by the adapter to the wireless charging apparatus, the DC/DC converter of the wireless charging apparatus may be controlled to operate in various power-drawing modes including the CV power-drawing mode, the CP power-drawing mode, etc. A stable charging process is thus ensured. When the DC/DC converter operates in the CP power-drawing mode, the charging power is controlled by the DC/DC converter, and at this point, the adapter is capable of providing sufficient power to meet the demand of the wireless charging apparatus for charging the terminal device. When the DC/DC converter operates in the CV power-drawing mode, the charging power is controlled by the adapter, and the adapter is no longer forced to supply the maximum charging power, which in turn eliminates the problem of charging interruption.

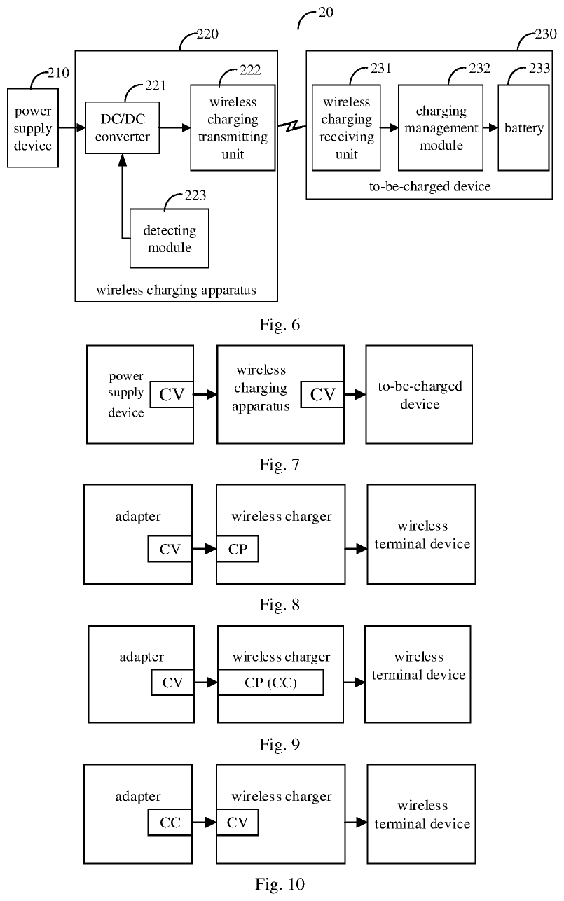

Based on the above-mentioned embodiments, in yet a further embodiment of the present disclosure, FIG. 5 illustrates a first schematic diagram for implementing the wireless charging according to an embodiment of the present disclosure, and FIG. 6 illustrates a second schematic diagram for implementing the wireless charging according to an embodiment of the present disclosure. As illustrated in FIG. 5 and FIG. 6, the wireless charging system 20 in embodiments of the present disclosure includes: a power supply device 210, a wireless charging apparatus 220 and a to-be-charged device 230.

As an example, in some embodiments of the present disclosure, the power supply device 210 is configured to supply electrical energy to the wireless charging apparatus 220. The power supply device 210 may include: a rectifier circuit, a voltage transformer circuit, a control circuit, and a charging interface, etc. The power supply device 210 may be capable of converting an alternating current (AC) power input into a direct current (DC) power output. The DC power output is supplied to the wireless charging apparatus 220. For example, the power supply device may be an adapter, a portable charger or a vehicle-mounted power supply.

Further, in some embodiments of the present disclosure, the power supply device 210 may also supply AC power directly to the wireless charging apparatus 220. For example, the power supply device 210 may be an AC power supply. When the power supply device 210 is an AC power supply, the wireless charging apparatus 220 further includes a circuit or module configured to convert the alternating current to the direct current, such as, a rectifier-filter circuit and a DC/DC converter etc.

The wireless charging apparatus 220 is configured to convert the direct current or the alternating current supplied by the power supply device 210 to the electromagnetic signal, for transmitting power wirelessly.

Further, as illustrated in the above-mentioned FIG. 4, in some embodiments of the present disclosure, the wireless charging apparatus 220 may include a DC/DC converter 221, a wireless charging transmitting unit 222, and a detecting module 223. Those skilled in the art should appreciate that, the compositional structure of the wireless charging apparatus 220 illustrated in FIG. 2 does not constitute a limitation on the wireless charging apparatus, and the wireless charging apparatus may include more or fewer components than illustrated, or a combination of certain components, or a different arrangement of components.

The power supply device 210 may be an ordinary adapter, a voltage-regulating adapter (i.e., the adapter itself is capable of adjusting a magnitude of the output voltage), or even a mobile power supply etc. Here, the DC/DC converter 221 is configured to perform a voltage conversion of direct current/direct current (DC/DC), to adjust the output voltage of the power supply device 210 to a constant voltage value and supply same to the wireless charging transmitting unit 222.

As an example, in the present disclosure, the DC/DC converter 221 may be a Boost converter circuit, a Buck converter circuit, a Buck-Boost converter circuit or a Flybuck converter etc. The embodiments of the present disclosure will not be specifically limited.

The wireless charging transmitting unit 222 is configured to convert the DC power supplied by the DC/DC converter 221 or the DC power supplied by the power supply device 210 to the AC power that is able to be coupled to the transmitting coil. The wireless charging transmitting unit 222 may convert the AC power to the electromagnetic signal for transmission through the transmitting coil.

In some embodiments of the present disclosure, the wireless charging transmitting unit 222 may include an inverter unit and a resonance unit. The inverter unit may include a plurality of switching tubes. A magnitude of emitted power may be adjusted by controlling the on-time (i.e., duty cycle) of the switching tubes. The resonance unit is configured to transmit electrical energy. For example, the resonance unit may include a capacitor and the transmitting coil. By adjusting an operating frequency of the resonant unit, the magnitude of the transmitting power of the wireless charging transmitting unit 222 may be adjusted.

In some embodiments of the present disclosure, the wireless charging apparatus 220 may be a wireless charging dock or a device with an energy storage function. When the wireless charging apparatus 220 is a device with the energy storage function, it may further include an energy storage module (e.g., a lithium battery 233). The energy storage module may obtain electrical energy from the external power supply device 210 and store the electrical energy. As a result, the energy storage module may supply electrical energy to the wireless charging transmitting unit 222. Those skilled in the art should appreciate that, the wireless charging apparatus 220 may obtain electrical energy from the external power supply device 210 by wired or wireless manner. In the wired manner, the wireless charging apparatus 220 is for example connected to the power supply device 210 through a charging interface (e.g., a Type-C interface or a USB interface, etc.) to obtain the electrical energy. In the wireless manner, the wireless charging apparatus 220 may for example further include a wireless charging receiving unit 231. The wireless charging receiving unit 231 may obtain the electrical energy from an apparatus having a wireless charging function in a wireless manner.

The detecting module 223 may be configured to control the wireless charging process. In some embodiments of the present disclosure, the detecting module 223 may perform real-time detection on at least one parameter of the charging parameters of the DC/DC converter 221. The charging parameters include the input current, the input voltage, the output current, and the output voltage etc. In this way, real-time monitoring of the charging parameters of the DC/DC converter 221 is enabled. A real-time monitoring function of the detecting module 223 may be achieved through an internal control circuit of the DC/DC converter 221 or through an external controller.

As an example, in the present disclosure, as shown in FIG. 5, the detecting module 223 may be a control circuit arranged within the DC/DC converter 221. The control circuit may perform detection on the charging parameters of the DC/DC converter 221 simultaneously.

As an example, in the present disclosure, as shown in FIG. 6, the detecting module 223 may be a controller arranged inside the wireless charging apparatus 220. The controller may control, through monitoring the charging parameters (e.g., the input voltage, the input current and other information), the DC/DC converter 221 to realize the functions of the CC, CV, CP, and CR modes.

Those skilled in the art should appreciate that, the wireless charging apparatus 220 may further include other related hardwares, logic devices, units, and/or coding to implement corresponding functions. For example, the wireless charging apparatus 220 may further include a display unit (e.g., a light-emitting diode or an LED display screen). The display unit is configured to display a real-time charging status (e.g., charging in progress or charging termination, etc.) during the wireless charging process. The embodiments of the present disclosure will not be specifically limited.

In some embodiments of the present disclosure, as illustrated in the above-mentioned FIG. 5, the to-be-charged device 230 includes a wireless charging receiving unit 231, a charging management module 232 and a battery 233. Those skilled in the art should appreciate that, the compositional structures of the to-be-charged device 230 illustrated in FIG. 4 and FIG. 5 do not constitute a limitation on the to-be-charged device. The to-be-charged device may include more or fewer components than illustrated, or a combination of certain components, or a different arrangement of components.

The power supply device 210 provides power supply to the wireless charging apparatus 220. The to-be-charged device 230 is placed on a surface of the wireless charging apparatus 220. The wireless charging apparatus 220 charges the battery 233 within the to-be-charged device 230 by means of electromagnetic induction. Here, a wireless connection is established between the wireless charging apparatus 220 and the to-be-charged device 230, and the two may also communicate with each other.

In some embodiments of the present disclosure, a wireless communication method includes, but is not limited to, a Bluetooth communication, a wireless Fidelity (Wi-Fi) communication, a high carrier-frequency based near-field wireless communication, an optical communication, an ultrasonic communication, an ultra-wideband communication and a mobile communication. The embodiments of the present disclosure will not be specifically limited.

The wireless charging receiving unit 231 is configured to convert the electromagnetic signal emitted by the wireless charging transmitting unit 222 of the wireless charging apparatus 220 to an alternating current (AC) through the receiving coil. The wireless charging receiving unit 231 is further configured to perform an operation such as rectifying and/or filtering on the AC, and convert the AC into a stable direct current. The direct current is supplied for charging the battery 233.

In some embodiments of the present disclosure, the wireless charging receiving unit 231 includes a receiving coil and an AC/DC converter unit. The AC/DC converter unit is configured to convert the alternating current received by the receiving coil to the direct current.

In some embodiments of the present disclosure, the battery 233 may include a single battery cell or a plurality of battery cells. When the battery 233 includes a plurality of battery cells, the plurality of battery cells are connected in series. As a result, a charging voltage that the battery 233 can bear is the sum of the charging voltages that the plurality of battery cells can bear. In this way, the charging speed may be increased, and heat generated during the charging process may be reduced.

In some embodiments of the present disclosure, the charging management module 232 is configured to boost or reduce the voltage of the DC power output from the wireless charging receiving unit 231.

FIG. 7 illustrates a schematic diagram of the operating mode of a common wireless charging apparatus. As illustrated in FIG. 7, the currently common wireless charging apparatus mainly controls its output to operate in the CV mode and does not control the input power-drawing mode of the DC/DC converter. That is, the power supply device charges the wireless charging apparatus in CV output operating mode. The wireless charging apparatus also charges the to-be-charged device in the CV output operating mode.

In the present disclosure, compared with the currently common scheme in which the DC/DC converter in the wireless charging apparatus is not controlled, the embodiments of the present disclosure add power-drawing control modes of the DC/DC converter such as CV, CC, and CP etc. In the CV power-drawing mode of the DC/DC converter, the charging power is allowed to be controlled by the power supply device within a certain controllable range, thereby reducing a dependence of the wireless charging apparatus on the rated power of the power supply device. In the event that the rated power of the power supply device is not capable of meeting the wireless charging peak power, the power supply device is allowed to support, to the best of its ability, the wireless charging apparatus to charge the to-be-charged device.

At the same time, with regard to the wireless charging apparatus, it is due to the control of the operating mode of the DC/DC converter, that the matched power supply device is no longer required to be rated at a very high power. As long as the peak power can reach the maximum value, the wireless charging apparatus may charge the to-be-charged device at the maximum capacity for a short time period. After the battery level of the to-be-charged device is gradually boosted, the power supply device also gradually returns to the rated power and supports the wireless charging apparatus to charge the to-be-charged device.

Further based on the above-mentioned FIG. 5 and FIG. 6, in some embodiments of the present disclosure, taking the adapter (the power supply device), a wireless charger (the wireless charging apparatus), and a wireless terminal device (the to-be-charged device) as the example, FIG. 8 illustrates a first schematic diagram of a wireless charging, FIG. 9 illustrates a second schematic diagram of the wireless charging, and FIG. 10 illustrates a third schematic diagram of the wireless charging.

As illustrated in FIG. 8, by detecting the charging parameter (at least one parameter of the input current, the input voltage, the output current and the output voltage) of the DC/DC converter, it may be determined that, the real-time output power of the DC/DC converter is relatively small. In other words, the real-time charging power of the wireless charger for charging the wireless terminal device is relatively small, and the charging demand of the wireless charger can be met by the adapter. At this point, the output mode of the adapter is the CV mode. The target operating mode of the DC/DC converter may be further determined as the CP mode.

In the present disclosure, during the initial phase of the charging process, the charging power supplied by the wireless charger to the wireless terminal device is relatively small. This is a charging period in which the charging power is low and constant. At this point, the power that the adapter is able to supply is perfectly sufficient to meet the demands of the wireless charger. Therefore, the DC/DC converter of the wireless charger operates at the CP power-drawing mode, and the adapter operates at the CV output mode.

As illustrated in FIG. 9, by detecting the charging parameter (at least one parameter of the input current, the input voltage, the output current and the output voltage) of the DC/DC converter, it may be determined that, the real-time output power of the DC/DC converter has reached the peak power corresponding to the wireless terminal device. In other words, it may be determined that, the real-time charging power of the wireless charger has been boosted to the power upper limit. If the power supplied by the adapter is able to meet the charging demand of the wireless charger at this time, i.e., the adapter may also supply the charging power that meets the power upper limit within a short time period, then at this point, the output mode of the adapter is the CV mode. Correspondingly, the target operating mode of the DC/DC converter may be determined by the wireless charger as the CP mode or the CC mode.

In the present disclosure, after entering the rapid charging phase, the charging power of the wireless charger for charging the wireless terminal device is boosted to the peak power, and it is a charging period in which the power is high and the current is limited. At this point, the adapter enters into a short-term maximum power mode, supplies power that meets the maximum power demand of the wireless charger. The DC/DC converter of the wireless charger operates at the CP power-drawing mode or the CC power-drawing mode, and the adapter operates at the CV output mode.

As illustrated in FIG. 10, by detecting the charging parameter (at least one parameter of the input current, the input voltage, the output current and the output voltage) of the DC/DC converter, it may be determined that, the real-time output power of the DC/DC converter is continuously growing. In other words, it is determined that the real-time charging power of the wireless charger needs to be gradually boosted to the power upper limit. If the power supplied by the adapter does not meet the charging demand of the wireless charger at this point, for example, prior to the real-time output power of the DC/DC converter reaches the peak power corresponding to the wireless terminal device, the input voltage of the DC/DC converter begins to decrease. In other words, the charging power that meets the power upper limit can't be supplied within a short time period. At this point, the output mode of the adapter switches to the CC mode. Correspondingly, the target operating mode of the DC/DC converter may be determined by the wireless charger as the CV mode.

In the present disclosure, after entering the rapid charging phase, the charging power of the wireless charger for charging the wireless terminal device may be gradually boosted to the peak power. If the power supplied by the adapter to the wireless charging apparatus does not meet the maximum power demand of the wireless charger, a charging current of the adapter will keep increasing to the maximum current value. At this point, the adapter would switch to the CC output mode. Correspondingly, the DC/DC converter of the wireless charger would switch to operate in the CV power-drawing mode. In the CV power-drawing mode, the DC/DC converter is only configured to carry out power transmission. The DC/DC converter is no longer forced to obtain the maximum power from the adapter. The control authority of the charging power is handed over to the adapter. At this point, it is a charging period in which the power is variable.

As illustrated in FIG. 10, by detecting the charging parameter (at least one parameter of the input current, the input voltage, the output current and the output voltage) of the DC/DC converter, it may be determined that, the real-time output power of the DC/DC converter has reached the corresponding peak power of the wireless terminal device. In other words, the real-time charging power of the wireless charger is boosted to the power upper limit. In some cases, the power supplied by the adapter can meet the charging demand of the wireless charger, but after providing the charging power that meets the power upper limit for a certain time period, the adapter is unable to continue to supply the maximum power and needs to enter the power reduction phase. In other words, the adapter needs to reduce the power to ensure its stable operation. For example, after the real-time output power of the DC/DC converter reaches the peak power corresponding to the wireless terminal device for a certain time period, the input voltage of the DC/DC converter begins to decrease. Therefore, the output mode of the adapter may be switched from the CV mode to the CC mode. Correspondingly, the target operating mode of the DC/DC converter may be determined by the wireless charger as the CV mode.

In the present disclosure, after entering the rapid charging phase, the charging power of the wireless charger for charging the wireless terminal device may be gradually boosted to the peak power. In some cases, the power supplied by the adapter to the wireless charging apparatus is able to meet the maximum power demand of the wireless charger, and after charging the wireless charger at the maximum power for a time period, the adapter would enter the power reduction phase. The adapter would be switched to the CC output mode. Correspondingly, the DC/DC converter of the wireless charger may be switched to operate at the CV power-drawing mode. The DC/DC converter is only configured to carry out the power transmission. The DC/DC converter is no longer forced to obtain the maximum power from the adapter. The control authority of the charging power is handed over to the adapter. At this point, it is the charging period in which the power is variable.

In other words, in some embodiments of the present disclosure, after operating in the rapid charging mode for a time period, the adapter is at this point unable to continue providing the maximum power, and needs to reduce the power to ensure its own stable operation. The adapter would thus enter the power reduction phase. At this point, the adapter reduces the output current and enters the CC output mode. The target operating mode of the DC/DC converter of the wireless charger is switched to the CV power-drawing mode. The charging power is determined by the output power of the adapter. Specifically, during the process in which the DC/DC converter operates in the CV power-drawing mode, the control of the charging power is performed by the adapter. The DC/DC converter of the wireless charger is only configured for power transmission. The DC/DC converter is no longer forced to obtain the maximum power. In contrast, the DC/DC converter operating in the CV power-drawing mode can avoid a case of an abnormal operation of the charging system (under-voltage protection or over-current protection, etc.). The abnormal operation of the charging system is triggered by inability of the conventional DC/DC power-drawing mode to meet the power-reducing demand of the adapter. The problem of intermittent charging or even the problem of failing to charge is thus solved.

As illustrated in FIG. 8, by detecting the charging parameter (at least one parameter of the input current, the input voltage, the output current and the output voltage) of the DC/DC converter, it may be determined that, the real-time output current of the DC/DC converter is decreasing. Meanwhile, the real-time input current of the DC/DC converter is decreasing. In other words, the charging power required by the wireless terminal device is gradually decreasing. The adapter is able to meet the demand of the wireless charger for wirelessly charging the wireless terminal device. At this point, the output mode of the adapter is the CV mode. Correspondingly, the target operating mode of the DC/DC converter may be determined by the wireless charger as the CP mode.

In the present disclosure, with the increase of charging duration, the battery level of the wireless terminal device is gradually boosted, the charging power required by the wireless terminal device is gradually decreased. It is the low-power charging period. The wireless charger enters the rapid-charging-exiting phase. Therefore, the charging power supplied by the wireless charger to the wireless terminal device would also gradually decrease. Accordingly, the drawn power of the wireless charger would also gradually decrease, then the output mode of the power supply device is the CV mode. Correspondingly, the target operating mode of the converter may be determined by the wireless charger as the CP mode.

Further, in some embodiments of the present disclosure, the wireless charging method proposed in the present disclosure is not limited to be performed by the wireless charging apparatus, but may also be performed by other devices, such as a mobile power supply device.

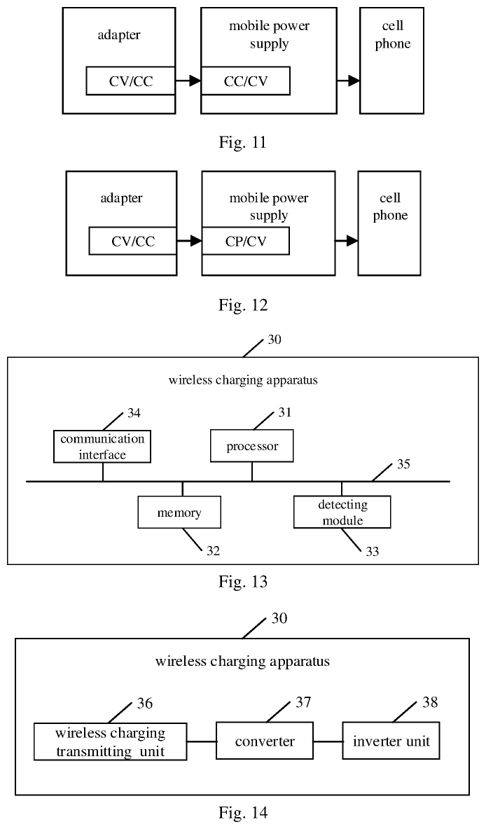

Further based on the above-mentioned FIG. 5 and FIG. 6, in some embodiments of the present disclosure, the adapter, the mobile power supply and the cell phone may be taken as an example. FIG. 11 is a first schematic diagram of an operating mode control during the charging process. FIG. 12 is a second schematic diagram of the operating mode control during the charging process.

As illustrated in FIG. 11, by detecting the charging parameter (at least one parameter of the input current, the input voltage, the output current and the output voltage) of the mobile power supply, in response to determining that the adapter is capable of meeting the charging demands of the mobile power supply, the output mode of the adapter is the CV mode, and it is further determined that, the target operating mode of the mobile power supply is the CC mode; in response to determining that the adapter is incapable of meeting the charging demands of the mobile power supply, the output mode of the adapter is the CC mode, and it is further determined that, the target operating mode of the mobile power supply is the CV mode.

As illustrated in FIG. 12, by detecting the charging parameter (at least one parameter of the input current, the input voltage, the output current and the output voltage) of the mobile power supply, in response to determining that the adapter is capable of meeting the charging demands of the mobile power supply, the output mode of the adapter is the CV mode, and it may be further determined that, the target operating mode of the mobile power supply is the CP mode; in response to determining that the adapter is incapable of meeting the charging demands of the mobile power supply, the output mode of the adapter is the CC mode, and it is further determined that, the target operating mode of the mobile power supply is the CV mode.

In some embodiments of the present disclosure, with regard to the mobile power supply, when the mobile power supply charges the cell phone, if the power supplied by the adapter to the wireless charging apparatus is not sufficient, then the adapter is allowed to automatically control the power. In other words, the adapter is allowed to switch from the CV output mode to the CC output mode. Correspondingly, at this point, the mobile power supply is no longer forced to obtain the maximum power from the adapter.

It can be seen that, the method of adjusting the power-drawing mode proposed in some embodiments of the present disclosure is effective for the converter unit between the power supply device (the adapter) and the to-be-charged device (the cell phone). When the rated power of the power supply device is insufficient, the power supply device is allowed to “supplying as much power as possible”. In this way, the dependence on the rated charging power of the power supply device may be reduced.

According to some embodiments of the present disclosure, the wireless charging method is provided. The wireless charging method includes: detecting, in response to the wireless charging apparatus performing wireless charging, the charging parameter of the converter, the charging parameter includes at least one parameter of the input current, the input voltage, the output current, and the output voltage; determining, based on the charging parameter, the target operating mode, the target operating mode is configured to determine the power-drawing mode of the converter; controlling the converter to switch to the target operating mode, and charging the to-be-charged device according to the target operating mode. In other words, in some embodiments of the present disclosure, during the charging process, based on the voltage and the current supplied by the wireless charging apparatus to the to-be-charged device for charging, and based on the voltage and the current supplied by the adapter to the wireless charging apparatus, the DC/DC converter of the wireless charging apparatus may be controlled to operate in various power-drawing modes including the CV power-drawing mode, the CP power-drawing mode, etc. A stable charging process is thus ensured. When the DC/DC converter operates in the CP power-drawing mode, the charging power is controlled by the DC/DC converter. At this point, the adapter is capable of providing sufficient power, to meet the demand of the wireless charging apparatus for charging the terminal device. When the DC/DC converter operates in the CV power-drawing mode, the charging power is controlled by the adapter. At this point, the adapter is no longer forced to supply the maximum charging power, which in turn eliminates the problem of charging interruption.

Based on the above-mentioned embodiments, in another embodiment of the present disclosure, FIG. 13 is a first schematic structural diagram illustrating a composition of the wireless charging apparatus according to an embodiment of the present disclosure. As illustrated in FIG. 13, the wireless charging apparatus 30 proposed in the embodiments of the present disclosure may include a processor 31, a memory 32 and a detecting module 33. Instructions that are executable by the processor 31 are stored in the memory 32.

The detecting module 33 is configured to: detect, in response to performing wireless charging, the charging parameter of the converter. The charging parameter includes at least one parameter of the input current, the input voltage, the output current, and the output voltage.

The processor 31 is configured to: determine, based on the charging parameter, the target operating mode. The target operating mode is configured to determine the power-drawing mode of the converter. The processor 31 is configured to control the converter to switch to the target operating mode, and charge the to-be-charged device based on the target operating mode.

The processor 31 is further configured to: determine, based on the output current and the output voltage, the real-time charging power; and determine, in response to the real-time charging power being less than the preset power threshold, the target operating mode as the constant power CP mode.

The processor 31 is further configured to: determine, based on the input current and the input voltage, the real-time input power; determine, based on the output current and the output voltage, the real-time charging power simultaneously; and determine, in response to the real-time charging power being equal to the real-time input power and the real-time charging power being equal to the power upper limit, the target operating mode as the CP mode.

The processor 31 is further configured to: prior to the operation of determining, based on the charging parameter, the target operating mode, determine the historical input current, the historical input voltage, the historical output current, and the historical output voltage of the converter.

The processor 31 is further configured to: determine, based on the input current and the input voltage, the real-time input power; determine, based on the output current and the output voltage, the real-time charging power simultaneously; and determine, in response to the real-time charging power being greater than or equal to the real-time input power, and the historical input voltage being greater than the input voltage, the target operating mode as the constant voltage CV mode.

The processor 31 is further configured to: determine, in response to the output current being less than the historical output current, and the input current being less than the historical input current, the target operating mode as the CP mode.

The processor 31 is further configured to: determine, based on the input current and the input voltage, the real-time input power; and determine the real-time input power as the target charging power, and charge the to-be-charged device according to the target charging power.

The processor 31 is further configured to: determine the real-time input power as the target charging power, and determine the input voltage as the target charging voltage; and charge the to-be-charged device according to the target charging power and the target charging voltage.

The detecting module 33 is further configured to: detect the charging parameter through the control circuit arranged in the converter; or, detect the charging parameter through the controller.

In some embodiments of the present disclosure, the above-mentioned processor 31 may be at least one selected from the group consisting of an application specific integrated circuit (ASIC), a digital signal processor (DSP), a digital signal processing device (DSPD), a programmable logic device (PLD), a field programmable gate array (FPGA), a central processing unit (CPU), a controller, a microcontroller, a microprocessor. For various devices, the electronics configured to perform the above-mentioned processor functions may also be other components. The embodiments of the present disclosure will not be specifically limited. The wireless charging apparatus 30 may further include a memory 32. The memory 32 may be coupled to the processor 31. The memory 32 is configured to store an executable program code. The program code includes computer operating instructions. The memory 32 may include a high-speed RAM memory. In some embodiments, the memory 32 may further include a non-volatile memory, such as at least two magnetic disk memories.

In some embodiments of the present disclosure, the wireless charging apparatus 30 may further include a communication interface 34 and a bus 35. The bus 35 is configured to connect the communication interface 34, the processor 31, and the memory 32. The bus 35 is configured for mutual communications between these devices.

In some embodiments of the present disclosure, the memory 32 may be configured to store instructions and data.

In actual applications, the above-mentioned memory 32 may be: a volatile memory, such as a random-access memory (RAM); or a non-volatile memory, such as a read-only memory (ROM), a flash memory, a hard disk drive (HDD) or a solid-state drive (SSD); or a combination of the above-mentioned kinds of memories. The memory 32 is configured to provide instructions and data to the processor 31.

In addition, each function module in embodiments of the present disclosure may be integrated into one processing unit, or each module may be physically separate, or two or more modules may be integrated into one unit. The above-mentioned integrated units may be embodied in the form of hardwares or software function modules.

If the integrated units are implemented in the forms of software function modules, and are not sold or used as independent products, then they may be stored in a non-transitory computer-readable storage medium. Based on such kind of appreciation, the technical scheme of the present embodiment essentially or a part thereof contributing to the related art or a part or all of it may be embodied in the form of a software product. The computer software product may be stored in a storage medium. The computer software product may include several instructions, which may enable a computer device (which may be a personal computer, a server, or a network device etc.) or a processor to implement all or a part of the steps of the method according to the present embodiment. The afore-mentioned storage medium may include: a USB flash drive, a removable hard disk, a ROM, a RAM, a magnetic disk or a CD-ROM and other medium that can store program codes.

Further, in some embodiments of the present disclosure, FIG. 14 is a second schematic structural diagram illustrating the composition of the wireless charging apparatus according to an embodiment of the present disclosure. As illustrated in FIG. 14, the wireless charging apparatus 30 proposed in the embodiments of the present disclosure may further include a wireless charging transmitting unit 36, a converter 37, and an inverter unit 38. The wireless charging apparatus 30, which consists of the wireless charging transmitting unit 36, the converter 37, and the inverter unit 38, may be configured to implement the wireless charging method proposed in the above-mentioned embodiments.

In some embodiments of the present disclosure, the wireless charging transmitting unit 36 may be the above-mentioned wireless charging transmitting unit 121 of FIG. 1 and the above-mentioned wireless charging transmitting unit 222 of FIG. 5. The wireless charging transmitting unit 36 is configured to convert the output voltage and the output current of the power supply device into a wireless charging signal (an electromagnetic signal) for transmission.

In some embodiments of the present disclosure, the converter 37 may be the above-mentioned DC/DC converter 122 of FIG. 2 and the above-mentioned DC/DC converter 221 of FIG. 5. The converter 37 is configured to scale the constant voltage received from the power supply device.

In some embodiments of the present disclosure, the inverter unit 38 may be the above-mentioned inverter 123 of FIG. 2. The inverter unit 38 is configured to convert the DC voltage (Vsdc) to the AC voltage (Vsac).

According to some embodiments of the present disclosure, a wireless charging apparatus is provided. The wireless charging apparatus is configured to: detect, when performing the wireless charging, the charging parameter of the converter, the charging parameter includes at least one parameter of the input current, the input voltage, the output current, and the output voltage; determine, based on the charging parameter, the target operating mode, the target operating mode is configured to determine the power-drawing mode of the converter; control the converter to switch to the target operating mode, and charge the to-be-charged device according to the target operating mode. In other words, in some embodiments of the present disclosure, during the charging process, based on the voltage and the current supplied by the wireless charging apparatus to the to-be-charged device for charging, and based on the voltage and the current supplied by the adapter to the wireless charging apparatus, the DC/DC converter of the wireless charging apparatus may be controlled to operate in various power-drawing modes. The various power-drawing modes includes the CV power-drawing mode, the CP power-drawing mode, etc. The stable charging process is thus ensured. When the DC/DC converter operates in the CP power-drawing mode, the charging power is controlled by the DC/DC converter. At this point, the adapter is capable of providing sufficient power, to meet the demand of the wireless charging apparatus for charging the terminal device. When the DC/DC converter operates in the CV power-drawing mode, the charging power is controlled by the adapter. At this point, the adapter is no longer forced to supply the maximum charging power, which in turn eliminates the problem of charging interruption.

In some embodiments of the present disclosure, a non-transitory computer-readable storage medium is provided. The non-transitory computer-readable storage medium may store a program. When the program is executed by a processor, the above-mentioned wireless charging method may be implemented.

In some embodiments, the program instructions corresponding to one of the wireless charging methods in the present embodiment may be stored in a storage medium such as a CD-ROM, a hard disk, a USB flash drive, etc. When the program instructions in the storage medium corresponding to one of the wireless charging methods is read or executed by an electronic device, the method may include the following operations: detecting, in response to performing the wireless charging, the charging parameter of the converter, the charging parameter includes at least one parameter of the input current, the input voltage, the output current, and the output voltage; determining, based on the charging parameter, the target operating mode, the target operating mode is configured to determine the power-drawing mode of the converter; and controlling the converter to switch to the target operating mode, to charge the to-be-charged device based on the target operating mode.

Those of ordinary skills in the art should appreciate that, embodiments of the present disclosure may be embodied as methods, systems, or computer program products. Thus, the present disclosure may take the forms of hardware embodiments, software embodiments, or embodiments that combine software and hardware aspects. Further, the present disclosure may take the form of a computer program product implemented on one or more computer usable storage medium. Computer usable program codes are contained in the computer usable storage medium. The computer usable storage medium includes, but is not limited to, a magnetic disk memory and an optical memory etc.

The present disclosure is described with reference to implementing flowcharts and/or block diagrams of methods, devices (systems) and computer program products according to some embodiments of the present disclosure. Each process and/or block in an implementing flowchart and/or a block diagram, and a combination of processes and/or blocks in the implementing flowchart and/or the block diagram, may be implemented by computer program instructions. These computer program instructions may be provided to the processor of a general-purpose computer, a specialized computer, an embedded processor or other programmable data processing device to generate a machine, such that the instructions executed by a processor of a computer or another programmable data processing device may generate an apparatus. The apparatus is configured to achieve the function specified in one or more processes of the implementing flowchart and/or in one or more blocks of the block diagram.

These computer program instructions may also be stored in a computer readable memory. The computer readable memory is capable of guiding a computer or other programmable data processing device to operate in a particular manner, such that the instructions stored in the computer readable memory produce an article of manufacture that includes an instruction apparatus. The instruction apparatus achieves the function specified in one or more processes of the implementing flowchart and/or one or more blocks of the block diagram.

These computer program instructions may also be loaded into the computer or another programmable data processing device, such that a series of operating steps are performed by the computer or the another programmable device, to generate a processing achieved by the computer. In this way, the instructions executed by the computer or the another programmable device provide steps for achieving the function specified in one or more processes of the implementing flowchart and/or in one or more blocks of the block diagram.

The above-mentioned descriptions are merely preferred embodiments of the present disclosure and are not intended to limit the protection scope of the present disclosure.

### INDUSTRIAL APPLICABILITY

In some embodiments of the present disclosure, during the charging process, based on the voltage and the current supplied by the wireless charging apparatus to the to-be-charged device for charging, and based on the voltage and the current supplied by the adapter to the wireless charging apparatus, the DC/DC converter of the wireless charging apparatus may be controlled to operate in various power-drawing modes. The various power-drawing modes include the CV power-drawing mode, the CP power-drawing mode, etc. A stable charging process is thus ensured. When the DC/DC converter operates in the CP power-drawing mode, the charging power is controlled by the DC/DC converter. At this point, the adapter is capable of providing sufficient power, to meet the demand of the wireless charging apparatus for charging the terminal device. When the DC/DC converter operates in the CV power-drawing mode, the charging power is controlled by the adapter. At this point, the adapter is no longer forced to supply the maximum charging power, which in turn eliminates the problem of charging interruption. The intelligence and stability of the wireless charging process is enhanced.

What is claimed is:

1. A wireless charging method, comprising:
detecting, in response to performing wireless charging, a charging parameter of a converter, wherein the charging parameter comprises at least one parameter of an input current, an input voltage, an output current, and an output voltage;
determining, based on the charging parameter, a target operating mode, wherein the target operating mode is configured to determine a power-drawing mode of the converter; and
controlling the converter to switch to the target operating mode, and charging a to-be-charged device based on the target operating mode.

2. The method as claimed in claim 1, wherein
the operation of determining, based on the charging parameter, the target operating mode comprises:
determining, based on the output current and the output voltage, a real-time charging power; and
determining, in response to the real-time charging power being less than a preset power threshold, the target operating mode as a constant power (CP) mode.

3. The method as claimed in claim 1, wherein
the operation of determining, based on the charging parameter, the target operating mode comprises:
determining, based on the input current and the input voltage, a real-time input power;
determining, based on the output current and the output voltage, a real-time charging power simultaneously; and
determining, in response to the real-time charging power being equal to the real-time input power and the real-time charging power being equal to a power upper limit, the target operating mode as a CP mode.

4. The method as claimed in claim 1, wherein
prior to the operation of determining, based on the charging parameter, the target operating mode, the method further comprises:
determining a historical input current, a historical input voltage, a historical output current, and a historical output voltage of the converter.

5. The method as claimed in claim 4, wherein
the operation of determining, based on the charging parameter, the target operating mode comprises:
determining, based on the input current and the input voltage, a real-time input power;
determining, based on the output current and the output voltage, a real-time charging power simultaneously; and
determining, in response to the real-time charging power being greater than or equal to the real-time input power, and the historical input voltage being greater than the input voltage, the target operating mode as a constant voltage (CV) mode.

6. The method as claimed in claim 4, wherein
the operation of determining, based on the charging parameter, the target operating mode comprises:
determining, in response to the output current being less than the historical output current, and the input current being less than the historical input current, the target operating mode as a CP mode.

7. The method as claimed in claim 2, wherein
the operation of charging the to-be-charged device based on the target operating mode comprises:
determining, based on the input current and the input voltage, a real-time input power; and
determining the real-time input power as a target charging power, and charging the to-be-charged device according to the target charging power.

8. The method as claimed in claim 5, wherein
the operation of charging the to-be-charged device based on the target operating mode comprises:
determining the real-time input power as a target charging power, and determining the input voltage as a target charging voltage; and
charging the to-be-charged device according to the target charging power and the target charging voltage.

9. The method as claimed in claim 1, further comprising:
detecting the charging parameter through a control circuit arranged in the converter; or
detecting the charging parameter through a controller.

10. A wireless charging apparatus, comprising a processor, a memory and a detecting module, the memory storing an instruction capable of being executed by the processor, wherein
the detecting module is configured to:
detect, in response to performing wireless charging, a charging parameter of a converter, the charging parameter comprises at least one parameter of an input current, an input voltage, an output current, and an output voltage; and
the processor is configured to:
determine, based on the charging parameter, a target operating mode, the target operating mode is configured to determine a power-drawing mode of the converter; and
control the converter to switch to the target operating mode, and charge a to-be-charged device based on the target operating mode.

11. The wireless charging apparatus as claimed in claim 10, wherein
the processor is further configured to:
determine, based on the output current and the output voltage, a real-time charging power; and
determine, in response to the real-time charging power being less than a preset power threshold, the target operating mode as a constant power (CP) mode.

12. The wireless charging apparatus as claimed in claim 10, wherein
the processor is further configured to:
determine, based on the input current and the input voltage, a real-time input power;
determine, based on the output current and the output voltage, a real-time charging power simultaneously; and
determine, in response to the real-time charging power being equal to the real-time input power and the real-time charging power being equal to a power upper limit, the target operating mode as a CP mode.

13. The wireless charging apparatus as claimed in claim 10, wherein
the processor is further configured to:
prior to the operation of determining, based on the charging parameter, the target operating mode, determine a historical input current, a historical input voltage, a historical output current, and a historical output voltage of the converter.

14. The wireless charging apparatus as claimed in claim 13, wherein
the processor is further configured to:
determine, based on the input current and the input voltage, a real-time input power;
determine, based on the output current and the output voltage, a real-time charging power simultaneously; and
determine, in response to the real-time charging power being greater than or equal to the real-time input power, and the historical input voltage being greater than the input voltage, the target operating mode as a constant voltage (CV) mode.

15. The wireless charging apparatus as claimed in claim 13, wherein
the processor is further configured to: determine, in response to the output current being less than the historical output current, and the input current being less than the historical input current, the target operating mode as a CP mode.

16. The wireless charging apparatus as claimed in claim 11, wherein
the processor is further configured to:
determine, based on the input current and the input voltage, a real-time input power; and
determine the real-time input power as a target charging power, and charge the to-be-charged device according to the target charging power.

17. The wireless charging apparatus as claimed in claim 14, wherein
the processor is further configured to:
determine the real-time input power as a target charging power, and determine the input voltage as a target charging voltage; and
charge the to-be-charged device according to the target charging power and the target charging voltage.

18. The wireless charging apparatus as claimed in claim 10, wherein
the detecting module is further configured to:
detect the charging parameter through a control circuit arranged in the converter; or
detect the charging parameter through a controller.

19. The wireless charging apparatus as claimed in claim 10, further comprising:
a wireless charging transmitting unit and a converter.

20. A non-transitory computer-readable storage medium storing a program and applied in a wireless charging apparatus, wherein
the program, when being executed by a processor, is configured to implement a wireless charging method, the method comprises:
detecting, in response to performing wireless charging, a charging parameter of a converter, wherein the charging parameter comprises at least one parameter of an input current, an input voltage, an output current, and an output voltage;
determining, based on the charging parameter, a target operating mode, wherein the target operating mode is configured to determine a power-drawing mode of the converter; and
controlling the converter to switch to the target operating mode, and charging a to-be-charged device based on the target operating mode.
